(19) United States
(12) Patent Application Publication
(10) Pub. No.: US 2004/0073836 A1
(43) Pub. Date: Apr. 15, 2004

(54) Predecessor and successor type multiplex system

(76) Inventor: Kentaro Shimada, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/081,204

(22) Filed: Feb. 25, 2002

(30) Foreign Application Priority Data
Jun. 28, 2001 (JP) 2001-195687

(51) Int. Cl. G06F 11/00

(52) U.S. Cl. 714/25

(57) ABSTRACT

A multiplex system including a predecessor 10A and a successor 10B, an input data buffer 13 for temporarily storing input data to be supplied to the two systems, an output data buffer 14 for temporarily storing output data from the predecessor, a comparator 15 for comparing output data from the successor with output data from the predecessor stored in the output data buffer, a gate 16 for controlling delivering of the output data from the successor to the outside in accordance with an output of the comparator, and an execution controller 17 for confirming that the predecessor has normally completed a processing operation on a unit of input data and then allowing the successor to start an operation of processing input data which has already processed by the predecessor.

### BACKGROUND OF THE INVENTION

(1) Field of the Invention

The present invention relates to a multiplex system and, more particularly, to a multiplex system for executing the same input data process by a plurality of sub-systems to increase reliability of output data in a system such as a computer system for generating output data in accordance with input data supplied. Particularly, the invention relates to a technique for increasing the reliability of a whole system including software.

(2) Description of the Related Art

Conventionally, as a technique for improving the reliability of a system, a multiplex system consists two sub-systems performing the same function simultaneously and compares two output data generated in parallel from the sub-systems.

For example, proposed in Japanese Unexamined Patent Publication No. 9-198124 (prior art 1) is a multiplex control apparatus for making two control systems each outputting an analog control signal and an error signal in correspondence with an input signal operate simultaneously, and allowing a judging part to select and output a correct control signal from analog control signals output from the two control systems. Each control system repeats the same computation twice by a single arithmetic unit with respect to one input signal and, if the computation results is not consistent with each other, sets the error signal to “1”. The judging part checks the error signal and selects a correct control signal.

According to the prior art 1, each of the control systems generates the error signal independently of the other control system. Consequently, even when one of the control systems fails, the correct control signal can be selected by the judging part. The prior art 1 is achieved on condition that when one of the control systems fails, only the other control system is used, and no attention is paid to automatic recovery of the failed control system.

Japanese Unexamined Patent Publication No. 8-328888 (prior art 2) proposes a technique for increasing data integrity by repeating the same process by software twice in a computer system.

The prior art 2 discloses a software duplex technique. According to the technique, when data is input from an input device to a data processor, the input data and first output data generated by executing a processing program on the input data are stored into a memory device and, after that, the same processing program is executed again on the same input data read out from the memory device, thereby generating second output data. When the first and the second output data are consistent with each other, one of the output data is output to an output device.

The prior art 2 also discloses a duplex system configuration in which an input device, an output device, and a memory device are shared by two data processors which execute the same processing program in such a manner that one of the data processors generates output data and, after predetermined time, an equivalent output data is generated by the other data processor.

In the prior art 2, when the two output data are not consistent with each other, a message is output to a console to abort execution of the program. However, an automatic failure recovery technique is not described.

As for a duplex system having disk drives, as disclosed in Japanese Unexamined Patent Publication No. 10-3396 (prior art 3), for example, recovering from the failure is achieved by copying the contents (stored data) of a disk drive operating normally to a failed disk drive.

In a duplex system concerned with computer systems as in the prior art 2, however, since a plurality of computer systems operate in parallel, the data in the main memory of each computer is updated continuously. Therefore, when a failure occurs in one of the computer systems, the main memory of the other computer system is in an intermediate status. It is difficult to recover the failed computer system to the status before the failure occurs by copying the status of the normal computer.

In the prior art 2, the reliability of the output data is assured by comparing two output data generated by one or two computers. However, detection of a failure which occurs during the data processing to generate each output data is not disclosed.

### SUMMARY OF THE INVENTION

An object of the invention is to provide a duplex system or a multiplex system having three or more sub-systems, capable of recovering the status of a failed sub-system to a normal status.

Another object of the invention is to provide a multiplex system having a plurality of computer systems, capable of automatically recovering from a software failure occurred in one of the computer systems and therefore continuing the system operation.

To achieve the objects, a multiplex system according to the invention comprises a first system and a second system having the identical function to each other, an input data buffer for temporarily storing input data to be supplied to the first and second systems, a predecessor monitor for monitoring whether or not the first system has normally executed a processing operation on a unit of input data, and a successor controller for controlling start of data processing by the second system on the input data already processed by the first system in accordance with a result of monitoring by the predecessor monitor.

One of the features of the invention resides in that the multiplex system further includes means for copying, when an operation failure is detected in the first system by the predecessor monitor, a status of the second system to the first system and, at a predetermined timing, instructing the first system to re-process the input data which has not been successfully processed due to the operation failure.

A multiplex system according to the invention comprises a predecessor and a successor having the same function, an input data buffer for temporarily storing input data to be supplied to the predecessor and successor, an output data buffer for temporarily storing output data from the predecessor, a comparator for comparing output data from the successor with output data from the predecessor stored in the output data buffer, which correspond to each other, a gate for controlling outputting of the output data from the successor to the outside in accordance with a result of the comparison by the comparator, and an execution controller for confirming that the predecessor has normally completed a processing operation on a unit of input data, and then allowing the successor to start an operation of processing next input data which has been already processed by the predecessor if the predecessor has completed normally.

The execution controller has, for example, a predecessor monitor for monitoring whether or not the predecessor has normally executed an operation of processing input data, and a successor controller for controlling start of an operation of processing the next input data by the successor in accordance with a result of monitoring the operation of the predecessor by the predecessor monitor.

According to an embodiment of the invention, the multiplex system further includes status recovering means for copying, when an operation failure of the predecessor is detected by the predecessor monitor, the status of the successor before start of a processing of the next input data to the predecessor, thereby recovering the status of the predecessor to the same status as that in the successor, and the predecessor monitor has means for instructing the predecessor to re-process input data which has failed due to the operation failure at a predetermined timing after the status of the predecessor is recovered by the status recovering means.

The execution controller has means for allowing, when discrepancy of output data of the predecessor and successor is detected by the comparator, the predecessor and successor to re-execute processing on input data corresponding to the output data. The re-executing means confirms that the predecessor has normally finished the re-execution of processing on the input data, and then allows the successor to re-execute the processing on the input data if the predecessor has normally finished.

One of the features of the multiplex system according to the invention resides in that the predecessor monitor includes time-out detecting means for detecting whether or not a result is obtained within predetermined time after processing on a unit of input data is started.

Another feature of the multiplex system according to the invention resides in that the multiplex system further includes switching means switching the successor controller from a normal mode to a reduced mode, when a failure occurs in re-processing on the same input data by the predecessor, thereby to allow the successor controller to consecutively start processing operation on next input data by the successor regardless of a result of monitoring the operation of the predecessor by the predecessor monitor, and to deliver output data from the successor system to the outside via the gate. When the number of repetition of the re-processing on the same input data by the predecessor becomes a predetermined number, the switching means may switch the successor controller to the reduced mode in response to a failure notification generated by the predecessor monitor.

The above-described features of the invention can be also applied to a multiplex system having n (n>3) systems. In this case, for example, it is sufficient to dispose a plurality of execution controllers while using the i-th system (i=1 to n−1) as a predecessor for the (i+1)-th system, check consistency of output data from at least two systems, and control the data output gate.

For example, a multiplex system according to an embodiment of the invention comprises first, second, and third systems having the same function, an input data buffer for temporarily storing input data to be supplied to the first, second, and third systems, an output data buffer for temporarily storing output data from the first system, a comparator for comparing output data from the second system with output data from the first system stored in the output data buffer which correspond to each other, a gate for controlling delivering of the output data from the second system in accordance with results of the comparison by the comparator, a first execution controller for confirming that the first system has normally completed a predetermined processing operation on a unit of input data, and allowing the second system to start an operation of processing the next input data already processed by the first system if the first system has normally completed, a second execution controller for confirming that the second system has normally completed a predetermined processing operation on a unit of input data, and allowing the third system to start an operation of processing the next input data already processed by the second system if the second system has normally completed, and means for copying a status of the third system to the first and second systems when discrepancy of output data is detected by the comparator.

The other objects, features, and operations of the invention will become apparent from embodiments described hereinbelow with reference to the drawings.

### BRIEF DESCRIPTION OF THE DRAWINGS

FIG. 1 is a block diagram showing an embodiment of a duplex system according to the invention.

FIG. 2 is a time chart for explaining the operation of the duplex system.

FIG. 3 is a block diagram showing an embodiment of a triplex system according to the invention.

FIG. 4 is a block diagram showing another embodiment of the triplex system according to the invention.

FIG. 5 is a time chart for explaining the operation of the triplex system shown in FIG. 4.

FIG. 6 is a block diagram showing another embodiment of the duplex system according to the invention.

FIG. 7 is a block diagram showing further another embodiment of the triplex system according to the invention.

FIG. 8 is a flowchart of an example of an execution control performed to increase the reliability of an output in the system according to the invention.

FIG. 9 is a block diagram showing further another embodiment of a duplex system according to the invention provided with a reduced-operation controller.

FIG. 10 is a block diagram showing further another embodiment of the duplex system according to the invention.

FIG. 11 is a block diagram specifically showing a predecessor monitor.

FIG. 12 is a block diagram showing a modification of the duplex system illustrated in FIG. 1.

FIG. 13 is a block diagram showing further another modification of the duplex system illustrated in FIG. 1.

### DESCRIPTION OF THE PREFERRED EMBODIMENTS

Some embodiments of the invention will be described hereinbelow with reference to the drawings.

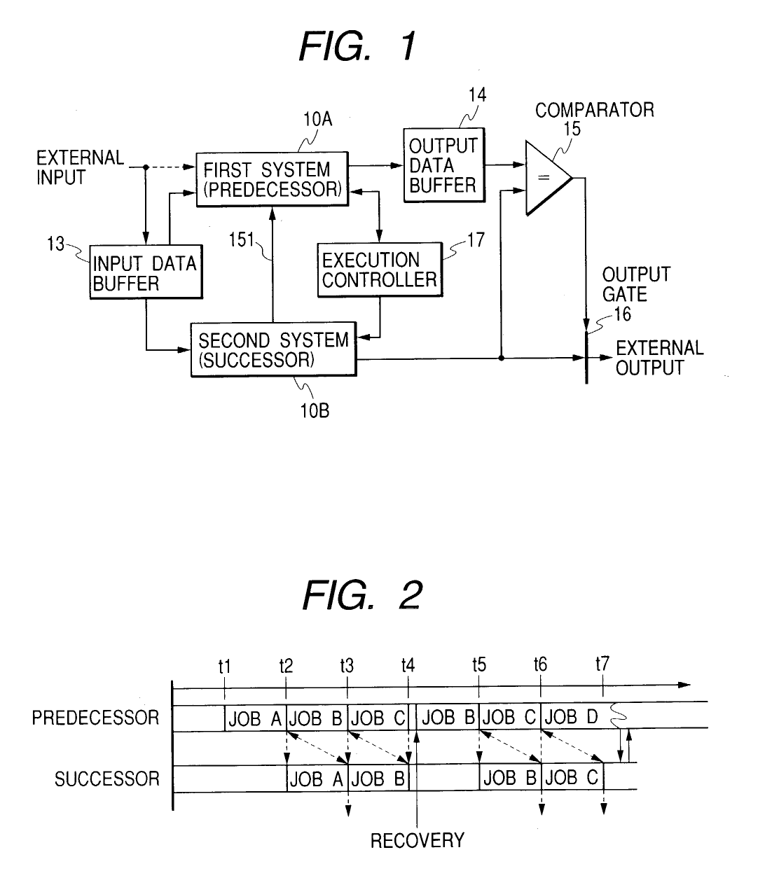

FIG. 1 shows a first embodiment of a duplex system according to the invention.

The duplex system has a first system (predecessor) 10A and a second system (successor) 10B which have the same function, an execution controller 17 for controlling execution of data processing of these systems, and an input data buffer 13 for temporarily storing input data (including commands) supplied from an external input device. The predecessor 10A consecutively processes data read out from the input data buffer 13. When a command for starting a process on the next data is received from the execution controller 17, the successor 10B reads out the next data from the input data buffer 13 and processes the data. It is also possible to directly supply input data from the external input device to the predecessor 10A and, when an error occurs in the data process result, to process the data read out from the input data buffer 13.

The data output from the predecessor 10A as a result of the data processing on the input data is stored into an output data buffer 14. The execution controller 17 monitors whether or not the predecessor 10A operates without a failure and finishes normally the processing on the input data. After confirming that the predecessor 10A has normally finished the data processing, the execution controller 17 instructs the successor 10B to start the data processing on the next input data and the successor 10B processes input data which has been already processed by the predecessor 10A.

The data output from the successor 10B as a result of the processing on the input data is supplied to a comparator 15 and an output gate 16. The comparator 15 compares the output data of the successor 10B with output data of the predecessor 10A stored in the output data buffer 14. When the two output data are consistent with each other, the output gate 16 is opened and the output data of the successor 10B is output to the outside.

When a failure occurs in the predecessor 10A during the processing on the input data and the data process is not normally completed, the execution controller 17 instructs the successor 10B to output the internal status of the successor 10B to a signal line 151, in place of the command to start the next data process, and instructs the predecessor 10A to re-start the processing on the same input data as the data in which the failure occurs, at a predetermined timing.

In this case, the initial status of the data processing in the successor 10B is copied to the predecessor 10A. Consequently, the status of the predecessor 10B is recovered to the status just before. the data processing that could not be normally completed previously, and the data processing on the same input data as the previous data processing is executed again by the predecessor 10A.

According to the configuration of the embodiment, even when a software failure occurs in the predecessor 10A, the system can be automatically recovered from the failure and the data processing can be executed again on the input data which could not been normally processed at the first time. Since the comparator 15 confirms the consistency in the data processing results by the predecessor and successor and inconsistent data cannot pass through the output gate 16, an adverse influence on the outside due to an erroneous data processing result can be prevented.

When the results of the data processing by the predecessor 10A and the successor 10B are not consistent with each other, the predecessor 10A is instructed to process input data preceding the immediately processed input data. After the predecessor normally finishes the data processing, the successor 10B is instructed to process the immediately preceding input data, thereby enabling both the predecessor 10A and successor 10B to re-execute the processing on the same input data which has already been processed.

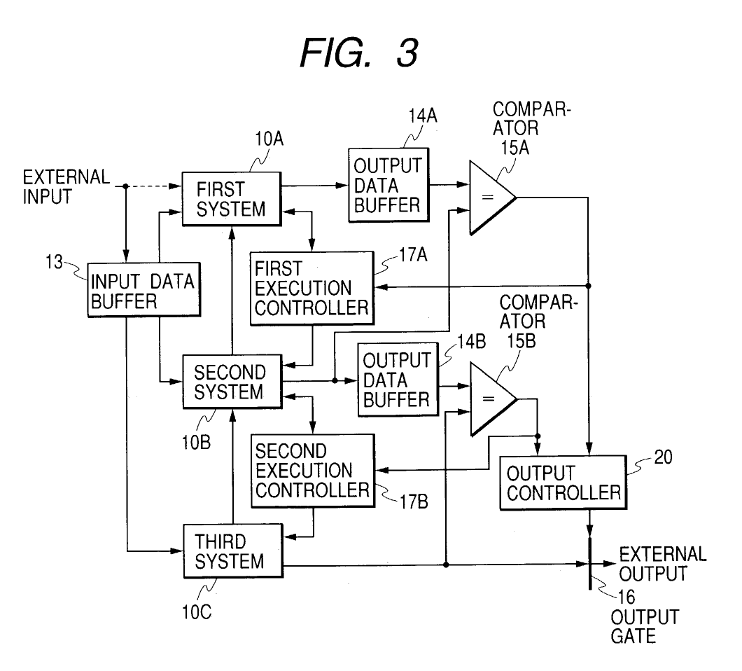

FIG. 2 is a time chart showing the operation of the duplex system illustrated in FIG. 1.

Jobs A to D show a series of data processes executed by the predecessor 10A and successor 10B to obtain an output result with respect to a unit of input data including an input command, respectively. It is assumed now that as long as the predecessor 10A and successor 10B normally performs data processing, each job is completed within predetermined time T (hereinbelow, called a job cycle). The predecessor 10A processes new input data every job cycle T, the successor 10B processes the same input data behind one job cycle T, the comparator 15 compares two output data at every job cycle T, and the execution controller 17 determines the status of the data processing of the predecessor 10A at every job cycle T.

In FIG. 2, the predecessor 10A starts the job A at time t1 and it is confirmed that the job A is normally completed at time t2, and then, in response to the command to start next data processing (job A) from the execution controller 17, the successor 10B starts the execution of the job A. On the other hand, the predecessor 10A starts execution of the next job B.

When the successor 10B finishes the job A at time t3, the comparator 15 compares the result of the job A processed by the successor 10B with the result of the job A processed by the predecessor 10A in the preceding cycle. When the two results are consistent with each other, the result of the successor 10B is output to the outside via the output gate 16. When the execution of job B by the predecessor 10A is normally finished at time t3, the successor 10B starts execution of the job B, and the predecessor 10A starts execution of the next job C. When the successor 10B finishes execution of the job B at time t4, the result is compared with the result of the predecessor 10A, and an operation similar to that performed at time t3 is repeated.

The example shown in FIG. 2 relates to the case where the result of the job B by the successor 10B are not consistent with that of the job B performed by the predecessor 10A at the time t4. In this case, according to the invention, the execution controller 17 instructs the predecessor 10A to re-execute job B which has been executed in the job cycle before the immediately preceding job cycle and instructs the successor 10B not to execute the next job C. When the predecessor 10A normally finishes the execution of the job B for the second time at time t5, the execution controller 17 instructs the successor 10B tore-execute job B which has been executed in the immediately preceding job cycle.

FIG. 2 shows the case where the second execution of the job B by the successor 10B is normally finished at time t6 and the result is consistent with the result of the predecessor 10A. The result of the job B by the successor 10B is output to the outside for the first time. After confirming that the predecessor 10A has normally finished executing the job C, the execution controller 17 instructs the successor 10B to start executing the job C.

FIG. 2 shows the case where some failure occurs during execution of the job D by the predecessor 10A at time t7 when the processing result of the job C is output to the outside. In this case, the execution controller 17 notifies a management terminal of the system of the failure, interrupts the predecessor 10A, and copies the internal status of the successor 10B into the predecessor 10A, thereby recovering the status of the predecessor 10A to the status before the start of the job D. After that, the execution controller 17 instructs the predecessor 10A to re-execute the data processing (job D) on the same input data as that in the preceding job cycle. After the predecessor 10A normally completes the job D, the successor 10B is instructed to start executing the next data processing (job D).

FIG. 3 shows an embodiment of a triplex system according to the invention.

In the embodiment, in addition to the first system 10A (predecessor) and the second system (successor) 10B shown in FIG. 1, a third system 10C is used. A first execution controller 17A confirms normal completion of the job in the first system 10A, and instructs the second system 10B to execute the next job. A second execution controller 17B confirms normal completion of a job in the second system 10B and instructs the third system 10C to execute the next job. When all the results of the first, second, and third systems are consistent with one another, the result of the third system is output to the outside via the output gate 16. According to the embodiment, even in the case where each of the results of the systems 10A, 10B and 10C is not sufficiently reliable, the correctness of the output data to the outside can be greatly increased.

Input data from the outside is supplied to the first, second, and third systems 10A, 10B, and 10C via the input data buffer 13 in a manner similar to FIG. 1. To the first system 10A, input data may be directly supplied. The output data of the first system 10A is stored in anoutputbuffer 14A and compared with output data of the second system 10B by a comparator 15A. The output data of the second system 10B is stored in an output data buffer 14B and compared with output data of the third system 10C by a comparator 15B.

Results of the two comparators 15A and 15B are supplied to an output controller 20. The output controller 20 holds the results of the comparator 15A and, when the result is obtained from the comparator 15B, the output gate 16 can be opened to output the output data from the third system 10C.

The first and second execution controllers 17A and 17B have the function similar to that of the execution controller 17 in FIG. 1. Namely, each of them checks whether the predecessor 10A (10B) has normally finished one job, and instructs the successor 10B (10C) to start the next job which has been normally finished by the predecessor if the predecessor has normally finished the job. When the predecessor did not normally finish the job, the execution of the job by the successor is inhibited, the internal status of the successor is copied to the predecessor, and the predecessor is allowed to re-process the same input data as that of the previous time. When the result of the predecessor 10A (10B) and that of the successor 10B (10C) are not consistent with each other, the first (second) execution controller 17A (17B) instructs the predecessor 10A (10B) to re-process data in the job cycle preceding to the immediately preceding job cycle, and after the predecessor normally finishes the data processing, instructs the successor 10B (10C) to process the data in the immediately preceding job cycle.

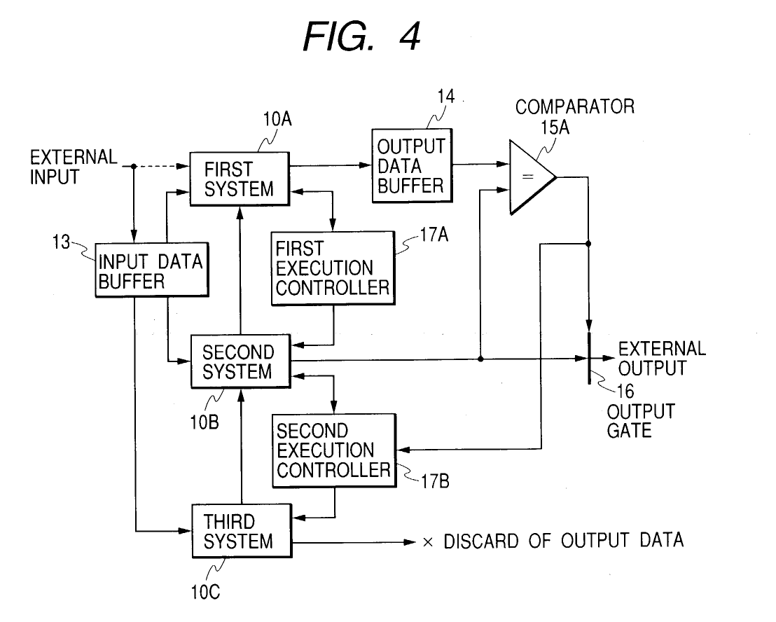

FIG. 4 shows another embodiment of a triplex system according to the invention.

In the embodiment, in a manner similar to the embodiment of FIG. 3, the triplex system has the first, second, and third systems 10A, 10B, and 10C, the first execution controller 17A for confirming the normal completion of a job by the, first system 10A and instructing the second system 10B to execute the next job, and the second execution controller 17B for confirming the normal completion of a job by the second system 10B and instructing the third system 10C to execute the next job.

In the embodiment, when consistency of results of the first and second systems is confirmed by the comparator 15A, the output gate 16 is opened to output the result of the second system 10B. When the second system 10B normally finishes a job, the third system 10B executes the job, which has been normally completed by the second system, in response to a command from the second execution controller 17B. The result of the third system is discarded and is not output to the outside.

In the case where the first system 10A cannot normally finish a job, the first execution controller 17A performs control function to copy the status of the second system 10B into the first system 10A and to allow the first system to re-execute the failed job. Similarly, when the second system 10B cannot normally finish the job, the second execution controller 17B performs control function to copy the status of the third system 10C into the second system 10B, and to allow the second system to re-execute the failed job.

The embodiment is characterized in that an output of the comparator 15A is connected to the second execution controller 17B, and when the result of the first system 10A and the result of the second system 10B are not consistent with each other, by means of a command from the second execution controller 17B, the status of the third system 10C is copied into both the second system 10B and the first system 10A, so that the two systems can re-read the input data already processed in the immediately preceding job cycle or in the job cycle preceding to the immediately preceding job cycle from the input data buffer 13 and re-execute the same job.

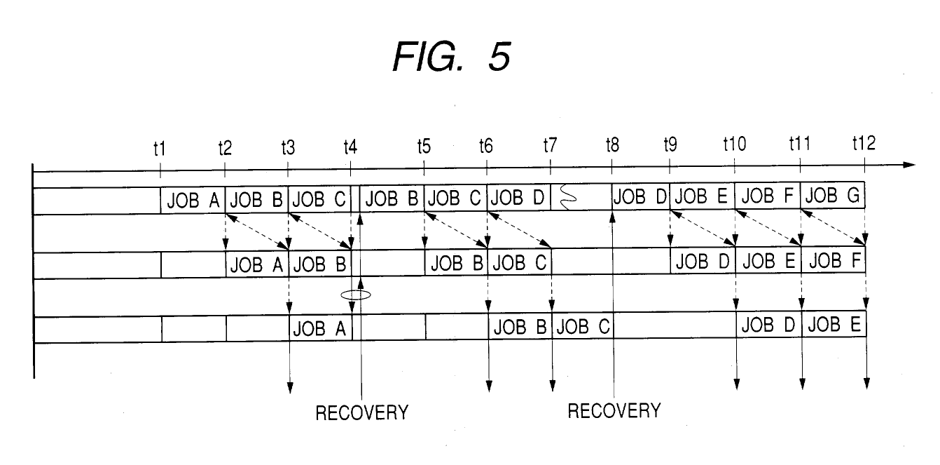

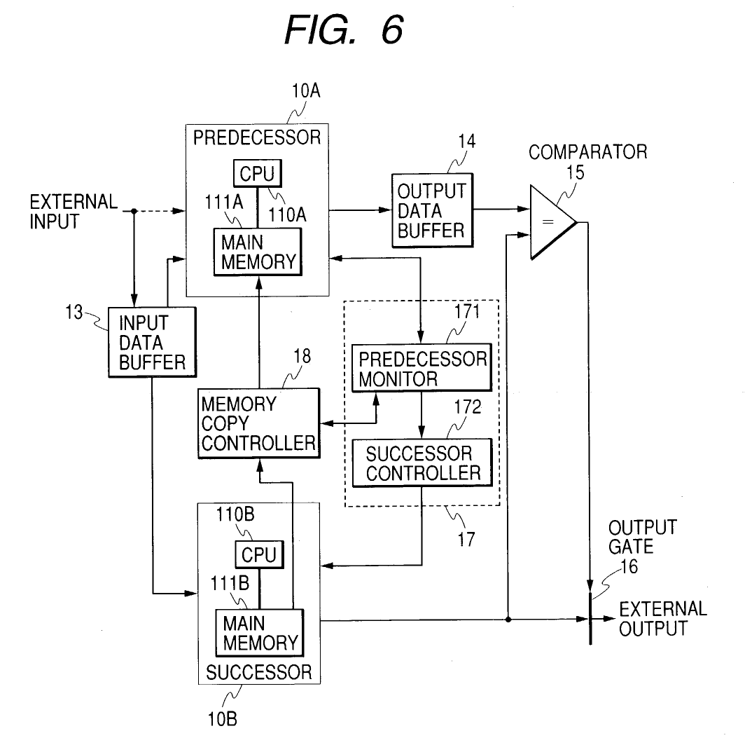

FIG. 5 is a time chart showing the operation of the triplex system illustrated in FIG. 4.

The first system 10A starts the job A at time t1. When the first execution controller 17A confirms the normal completion of the job A at time t2, the second system 10B starts the job A. At this time, the first system starts the next job B. When the second system 10B normally finishes the job A, at time t3, the processing results of the first and second systems are compared with each other by the comparator 15A. When they are consistent with each other, the processing result of the second system 10B is output to the outside. And then, the third system 10C starts the job A, the second system 10B starts the job B, and the first system 10A starts the job C.

As shown in the time chart, when the processing result of the job B executed by the second system and that of the job B by the first system are not consistent with each other at time t4, execution of the job B by the third system 10C is inhibited, and the status immediately after completion of the job A in the third system, that is, the status just before the job B is executed is copied to the first and second systems. In this case, by means of a command from the first execution controller 17A, the first system 10A re-reads input data, which has been processed in the job cycle previous to the immediately finished job cycle, from the input data buffer 13, and re-executes the job B. The second system is prevented from re-executing the job B until the first system 10A normally finishes the job B. When consistency of the execution results of the job B by the first and second systems is confirmed at time t6, the third system 10C starts executing the job B for the first time.

At time t7, in the case where a failure occurs in the first system and the job D cannot be normally completed when the second system normally finished the job C, execution of the next job D by the second system 10B is inhibited by a command from the first execution controller 17A, the status of the second system is copied to the first system 10A, and the status of the first system is recovered to the status before execution of the job D is started. By a command from the first execution controller 17A, the first system 10A reads out the same input data as that in the preceding cycle from the input data buffer 13 and re-executes the job D. In a manner similar to the case of the job B, when the normal completion of the job D by the first system is confirmed at time t9, the second system starts executing the job D that has been inhibited until then.

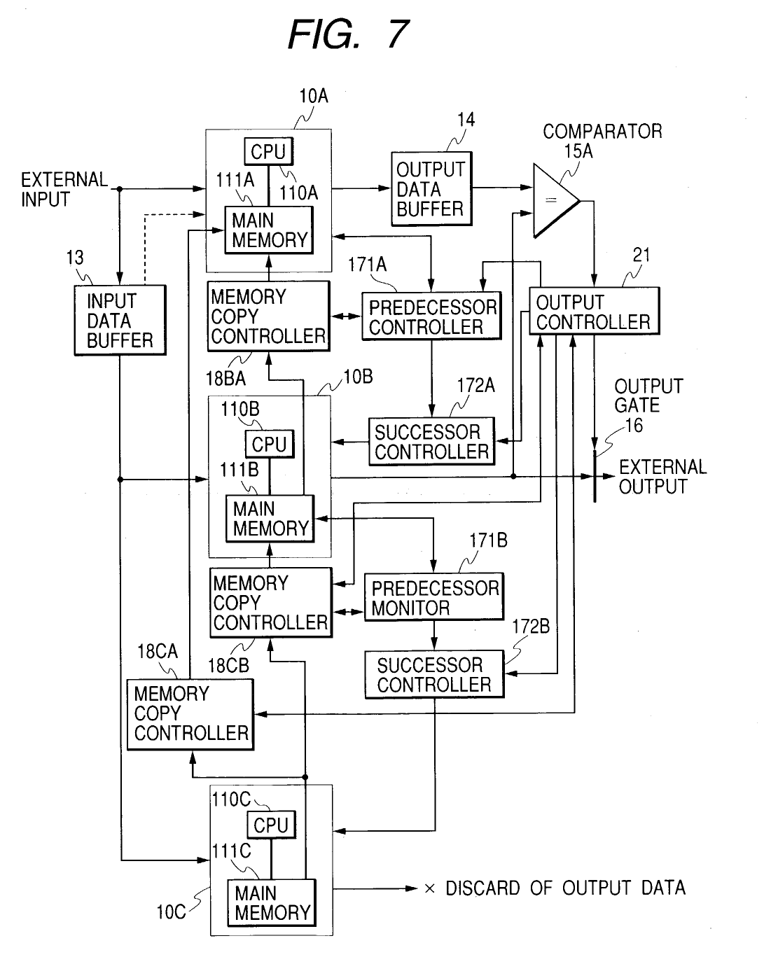

FIG. 6 shows an example of a duplex system to which computer systems having CPUs (110A, 110B) and main memories (111A, 111B) are applied as the first and second systems 10A and 10B, respectively.

The execution controller 17 includes a predecessor monitor 171 for monitoring whether or not the first system (predecessor) 10A operates without a failure and controlling re-execution of a data process by the predecessor, and a successor controller 172 for controlling execution of a process by the second system (successor) 10B.

In the case where the result is obtained without a failure from the first system 10A, in response to a notification of normal completion from the predecessor monitor 171, the successor controller 172 instructs the second system 10B to start executing the next data processing (next job). When a failure occurs in the first system 10A and the data processing cannot be normally finished, the predecessor monitor 171 does not output the normal completion notification. Consequently, the next job execution start command is not output from the successor controller 172 to the second system 10B, and the second system enters a command waiting status. In this case, the predecessor monitor 171 issues, in place of the normal completion notification, a status recovery command to a memory copy controller 18.

On receipt of the status recovery command, the memory copy controller 18 copies the contents of the main memory 111B of the second system to the main memory 111A of the first system, thereby enabling the status of the first system (predecessor) in which a software failure occurs in the immediately preceding job cycle to be recovered to the normal status before the job starts. The status of the internal registers of the CPU 110B may be copied to the CPU 110A to set the first system 10A to the same status as that of the second system 10B including the internal status of the CPU.

FIG. 7 shows an example of a triplex system to which computer systems having CPUs (110A, 110B, and 110C) and main memories (111A, 111B, and 111C) are applied as the first, second, and third systems 10A to 10C, respectively.

Between the first and second systems 10A and 10B, in a manner similar to FIG. 6, the first execution controller 17A constructed by a predecessor monitor 171A and a successor controller 172A and a memory copy controller 18BA are connected. Between the second and third systems 10B and 10C, the second execution controller 17B constructed by a predecessor monitor 171B and a successor controller 172B and a memory copy controller 18CB are connected. Between the first and third systems 10A and 10C, a memory copy controller 18CA is connected. In the embodiment, the result of the second system 10B is output to the outside via the output gate 16. The output gate 16 is controlled with an output controller 21 in accordance with an output from the comparator 15A.

When the first system 10A finishes the job A normally, the successor controller 172A instructs the second system 10B to start executing the next job A. When the second system finishes executing the job A normally, the comparator 15A compares the result of the second system and the result of the job A performed by the first system 1A stored in the output data buffer 14, and notifies the output controller 21 of the comparison result.

When the comparator 15A confirms the consistency between the two results, the output controller 21 opens the output gate 16, outputs the result of the second system as output data to the outside, and outputs an execution acknowledge signal of the next job to the successor controller 172A in the first execution controller and the successor controller 172B of the second execution controller.

When both of a notification of normal completion of the job from the predecessor monitor 171A (171B) and an execution acknowledge signal of the next job from the output controller 21 are received, the successor controller 172A (172B) instructs the successor to start executing the next job. In response to next job execution start commands from the successor controllers 172A and 172B, the second and third systems 10B and 10C read out the next input data from the input data buffer 13 and execute the next job. The result of data by the third system is discarded without being output to the outside.

When the first system 10A cannot finish the job A normally, the predecessor monitor 171A issues a command for recovering the status of the predecessor to the memory copy controller 18BA. On receipt of the status recovery command, the memory copy controller 18BA copies the contents of the main memory 111B of the second system into the main memory 111A of the first system to bring the first system back to the status before execution of the job A. When the memory copy controller 18BA notifies the predecessor monitor 171A of completion of status recovery, the predecessor monitor 171A instructs the first system 10A to start executing a job in the immediately preceding cycle. In this case, the successor controller 172A enters a status of waiting for the notification of the normal completion from the predecessor monitor 171A, and the second system 10B is in the status of waiting for the next job execution start command from the successor controller 172A.

Similarly, when the second system 10B cannot normally finish the job A, a status recovery command of the predecessor (second system) is issued from the predecessor monitor 171B to the memory copy controller 18CB, and outputting of the next job execution start command from the successor controller 172B to the third system 10C is inhibited. On receipt of the status recovery command, the memory copy controller 18CB copies the contents of the main memory 111C of the third system to the main memory 111B of the second system to bring the second system back to the status before execution of the job A. The predecessor monitor 171B receives a notification of status recovery completion from the memory copy controller 18CB and instructs the second system 10B to start executing the job in the immediately preceding job cycle.

When a discrepancy signal is received from the comparator 15A, the output controller 21 closes the output gate 16, inhibits outputting of the next job execution permission signal to the successor controllers 172A and 172B, and outputs the status recovery command of the predecessor to the memory copy controllers 18CB and 18CA. As a result, the processing result of the second system 10B is discarded without being output to the outside. The contents of the main memory 111C of the third system are copied to the main memory 111B of the second system and the main memory 111A of the third system by the memory copy controllers 18CB and 18CA, thereby bringing the status of the first and second systems back to the status before execution of the job whose outputs did not consistent with each other.

When notification of status recovery completion are received from the memory copy controllers 18CB and 18CA, the output controller 21 instructs the predecessor controller 171A and successor controller 172A to re-execute the job whose outputs are not consistent with each other. In response to the command, the predecessor controller 171A instructs the first system 10A to start executing the job in the job cycle previous to the immediately preceding job cycle. When a notification of normal completion of the job is received from the predecessor controller 171A, the successor controller 172A instructs the second system 10B to start executing the job in the immediately preceding cycle. Thus, the job whose outputs are not consistent with each other is re-executed, and results of the data processing performed by the first and second systems are compared again with each other by the comparator 15A.

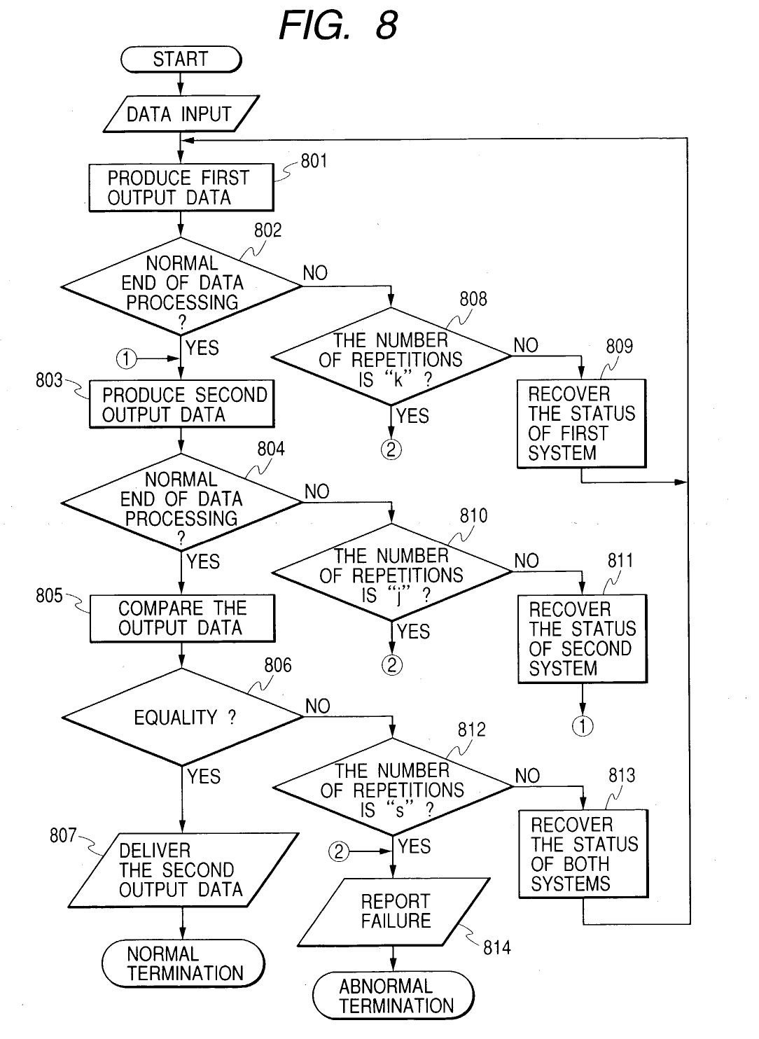

FIG. 8 is a flowchart of a control operation adopted by the triplex system shown in FIG. 7 to regulate the number of times of re-executing the job whose 4 outputs are not consistent with each other.

The first system 10A processes input data to obtain first output data (step 801), and the first predecessor monitor 171A determines whether a data process in the first system has been finished without any failure or not (802). When the data process has been normally finished by the first system 10A, the second system 10B starts to process the same input data to obtain second output data (803).

If a failure occurs in the data process of the first system, the output controller 21 determines whether or not the number of times of processing the same input data (the number of times of repeating the same job) in the first system has reached a predetermined number k (k>1) (808). If the number of repetitions does not reach k, the status of the first system is recovered (809), and the control sequence returns to step 801. If the number of repetitions has reached k, in step 814, the system administrator is notified of occurrence of a failure and the operation of the system is stopped (abnormal termination).

When the second predecessor monitor 171B determines whether or not the data process in the second system 10B has been finished without any failure (804) and the data processing is normally completed in the second system, the comparator 15A compares the first and second output data (805). When a failure occurs in the data process of the second system, the output controller 21 determines whet-her or not the number of times of processing the same input data (the number of repetitions of the same job) in the second system has reached predetermined number j (j>1) (810). If the number of repetitions has not reached j, the status of the second system is recovered (811), and the control sequence returns to step 803. If the number of repetitions has reached j, in step 814, the system administrator is notified of occurrence of a failure and the operation of the system is stopped (abnormal termination).

When consistency between the first and second output data is confirmed by the comparator 17A (806) the output controller 21 opens the output gate 16, outputs the second output data to the outside (807), and normally completes the control sequence of one job.

When inconsistency between the first and second output data is detected by the comparator 17A, the output controller 21 determines whether or not the number of repetitions of detecting the discrepancy of the output data has reached a predetermined number s (s>1) (812). If the number of repetitions does not reach the number s, the status of the first and second systems is recovered (813), and the control sequence returns to step 801. When the number of repetitions has reached the number s, the system administrator is notified of occurrence of a failure in step 814 and the operation of the system is stopped (abnormal completion).

As described above, by limiting the number of repetitions of the same job when a failure occurs and by delivering output data when two output data generated without any failure are consistent with each other, the reliability of the output data can be greatly increased.

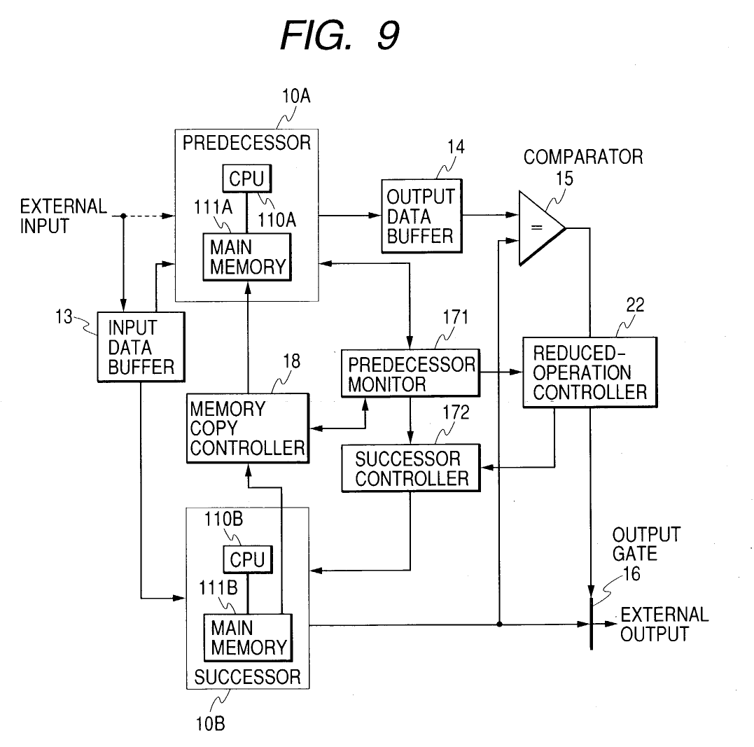

FIG. 9 shows the system configuration obtained by adding a degradation or reduced-operation controller 22 to the computer duplex system illustrated in FIG. 6.

While the predecessor 10A operates normally, the reduced-operation controller 22 controls the output gate 16 in accordance with an output of the comparator 15. In a manner similar to FIG. 6, when a failure occurs in the predecessor 10A, the predecessor monitor 171 instructs the memory copy controller 18 to recover the status of the predecessor 0A. If the data processing cannot be completed normally by the predecessor 10A even after repeating the status recovery and re-execution of the same job a predetermined number of times, the predecessor monitor 171 notifies the reduced-operation controller 22 of the occurrence of an unrecoverable abnormal status in the predecessor 10A.

On receipt of the abnormal status, the reduced-operation controller 22 sets the successor controller 172 into a reduced-operation mode and opens the output gate 16 so that the result of the data processing of the successor 10B is output to the outside irrespective of the output of the comparator 15. The successor controller 172 set in the reduced-operation mode instructs the successor 10B to start execution of jobs in the job cycles irrespective of notification of normal completion from the predecessor monitor 171. Consequently, the successor 10B is switched to the reduced-operation mode for consecutively reading out input data from the input data buffer 13, executing a job, and outputting a result of the data processing.

By providing the reduced-operation controller 22 in such a manner, when the predecessor 10A enters an unrecoverable failure state, the duplex system can be switched to an operation mode in which the data process is executed only by the successor 10B, thereby to increase the availability of the system.

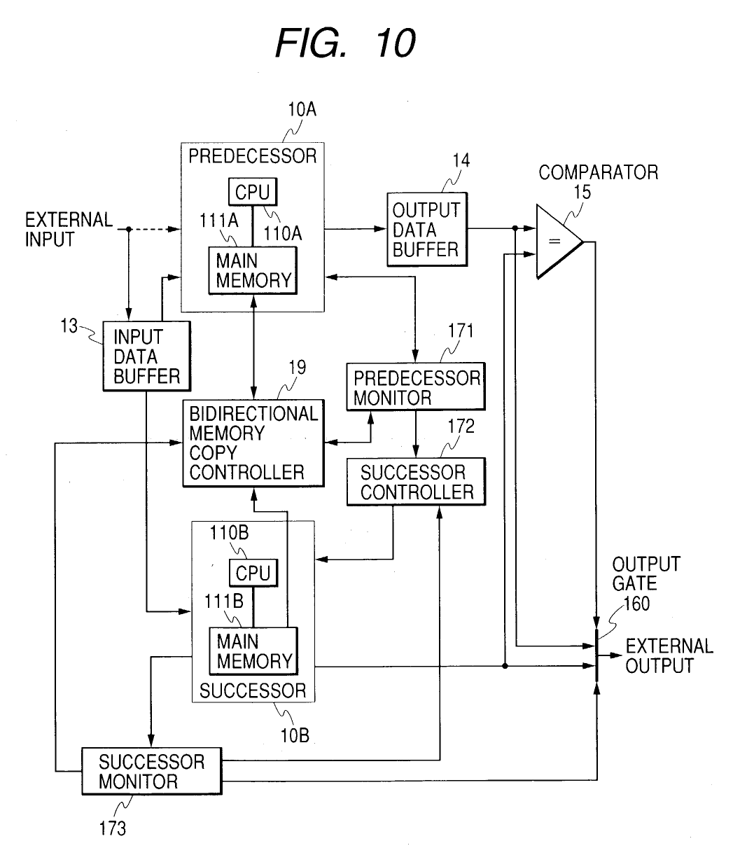

FIG. 10 shows a system configuration obtained by adding a third successor monitor 173 to the duplex system illustrated in FIG. 6, using a bidirectional memory copy controller 19 in place of the memory copy controller 18, and using an output gate 160 with a selector in place of the output gate 16.

The successor monitor 173 monitors whether or not the successor 10B has normally finished the data processing and, when a failure occurs in the successor 10B, sends a failure detection signal to the successor controller 172 to inhibit the outputting of the next job execution start command to the successor 10B. The successor monitor 173 outputs a status recovery command to the bidirectional memory copy controller 19 to copy the contents of the main memory 111A in the predecessor 10A to the main memory 111B of the successor 10B, thereby setting the successor 10B to the same status as that of the predecessor 10A.

In this case, the successor 10B already became unable to process input data which has been processed by the predecessor 10A in the immediately preceding job cycle, so that the successor monitor 173 controls the output gate 160 to output the output data of the predecessor stored in the output data buffer 14 to the outside.

According to the embodiment, when a failure occurs in the successor, the status of the successor can be returned to a status in which the next job can be started. With respect to input data that was not successfully processed by the successor, the data processing result can be supplied to an external system without a break by outputting the processing result of the predecessor to the outside.

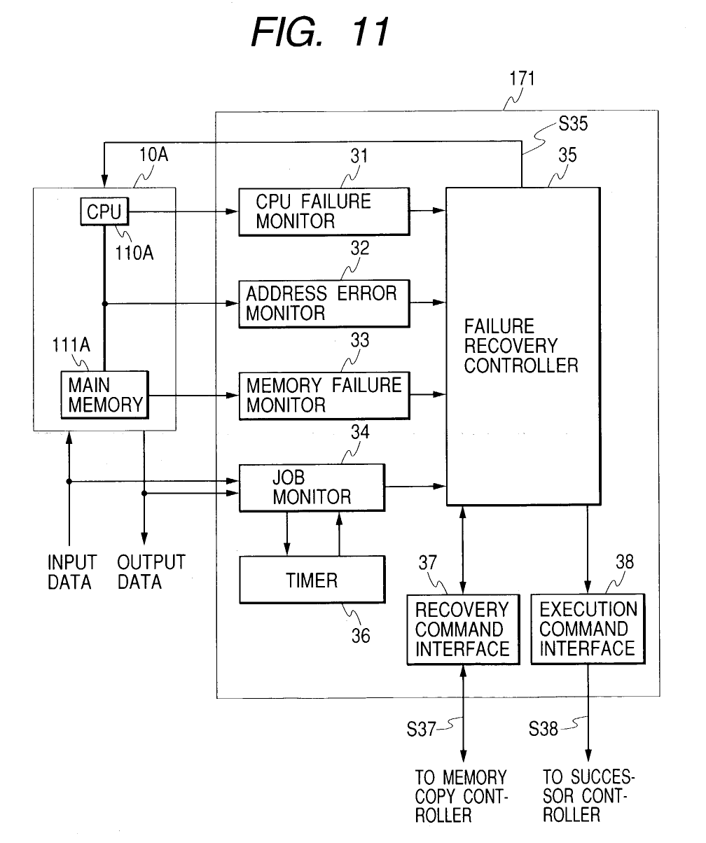

FIG. 11 shows an embodiment of the predecessor monitor 171 illustrated in, FIGS. 6 and 9. A configuration similar to that can be also applied to each of the predecessor monitors 171A and 171B illustrated in FIG. 7 and the predecessor monitor 171A illustrated in FIG. 10.

The predecessor monitor 171 includes a CPU failure monitor 31, an address error monitor 32, a memory failure monitor 33, a job monitor 34, a failure recovery controller 35 connected to the monitors 31 to 34, a timer 36 connected to the job monitor 34, and a recovery command interface 37 and an execution command interface 38 which are connected to the failure recovery controller 35.

When the first data of each job is input from the outside, the job monitor 34 starts operation of monitoring the data processing and instructs the timer 36 to start timer counting in the job cycle. Subsequently, the job monitor 34 monitors output data indicative of a result in the predecessor 10A. When time-out is notified from the timer 36 before output data appears, the failure recovery controller 35 is notified of occurrence of a time-out failure. In the case where a result is output from the predecessor before the timer 36 times out, the job monitor 34 resets the timer 36 to stop the counting operation. The failure recovery controller 35 is notified of the normal completion of the job.

The CPU failure monitor 31 monitors instruction execution of the CPU 110A. When a failure occurs in instruction execution or an exceptional event occurs in a result of instruction execution, the CPU failure monitor 31 notifies the failure recovery controller 35 of detection of a instruction execution failure.

The address error monitor 32 monitors an accessing address of the main memory 111B output from the CPU 110A. When the memory access address exceeds a predetermined address range determined by each job to be executed by the predecessor in response to external input data, detection of an erroneous memory access is notified to the failure recovery controller 35.

The memory failure monitor 33 monitors the operation of reading out and writing of data from and to the main memory 111B by the CPU, detects a failure which occurs in the reading or writing operation, and notifies the failure recovery controller 35 of the failure.

When a failure occurrence notification is received from any of the monitors 31 through 34, the failure recovery controller 35 sends a status recovery command S37 to the memory copy controller 18 via the recovery command interface 37. When a status recovery completion notification is received from the memory copy controller 18 via the recovery command interface 37, the failure recovery controller 35 sends a command S35 of re-execution of the previous job to the predecessor 10A in the next job cycle. When there is no failure occurrence notification from the monitors 31 through 33 and the normal completion notification is received from the job monitor 34, the failure recovery controller 35 sends a command S38 to start execution of the next job to the successor controller 172 via the execution command interface 38.

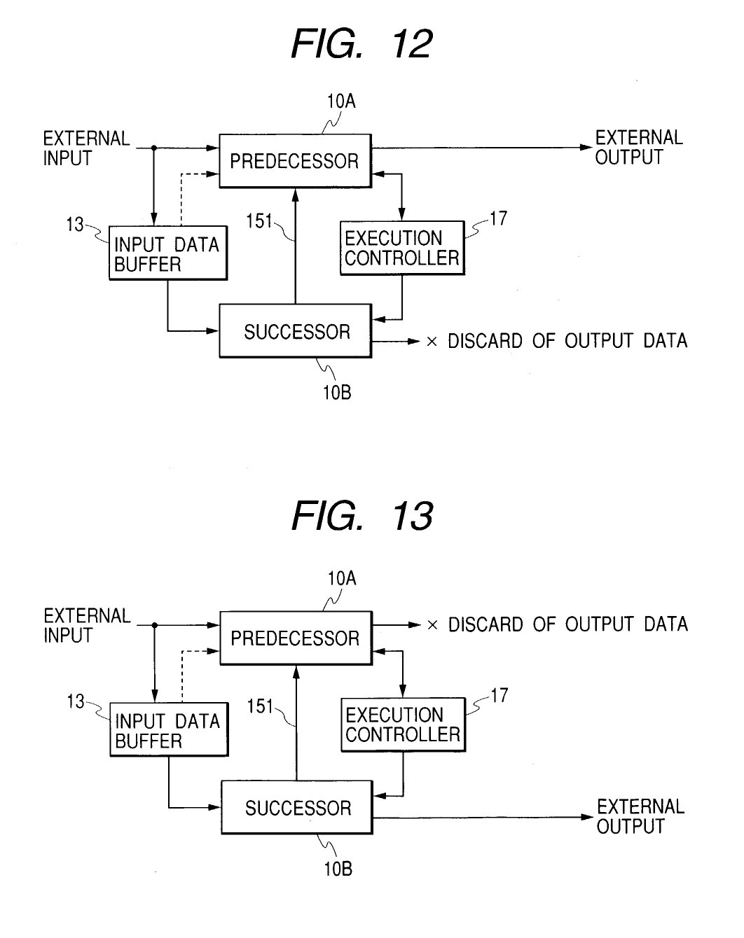

FIG. 12 shows a modification of the duplex system illustrated in FIG. 1.

The duplex system includes the predecessor 10A, A successor 10B, and execution controller 17, and outputs the data processing result of the predecessor 10A as it is without comparing the output data of the predecessor with the output data of the successor. The execution controller 17 monitors whether or not the predecessor 10A processes input data without a failure, confirms that the predecessor 10A has normally completed the data processing, and instructs the successor 10B to start the next job. Output data of the successor 10B is always discarded.

When a failure occurs in the predecessor 10A, the execution controller 17 inhibits execution of the next job by the successor 10B, copies the internal status of the successor 10B to the predecessor 10A via a signal line 151, and instructs the predecessor 10A to re-execute the preceding job.

In the embodiment, when a software failure occurs in the successor 10A, the successor 10B is used as the copy source of the internal status for recovering a failure. Although the degree of guaranteeing the correctness of output data is low as compared with the duplex system shown in FIG. 1, the system structure is simplified.

FIG. 13 shows another modification of the duplex system illustrated in FIG. 1.

The duplex system has the system configuration shown in FIG. 12, but output data of the predecessor 10A is discarded, and output data of the successor 10B is output to the outside. It is intended here to increase the reliability of output data by confirming that the predecessor 10A has processed input data without a failure and outputting the processing result of the same input data performed by the successor 10B to the outside.

In FIGS. 12 and 13, the result of the data processing by the predecessor or successor is output as it is to the outside. By disposing a gate in an output circuit of the predecessor or successor, a result of the data processing in which a failure occurs can be prevented from being output to the outside.

As obvious from the above description, according to the invention, after confirming that a predecessor has normally completed a data processing on a unit of input data, a successor is allowed to start the same data processing in a multiplex system. It enables a multiplex system to improve the reliability of data processing result output to the outside and to recover the status of a data processing system in which a failure has occurred. By controlling delivering of output data to the outside in accordance with confirmation of process completion of the system, an adverse influence outside in the case of a failure can be avoided.

According to the invention, particularly, when the predecessor and the successor are computer systems for processing input data in accordance with software (program), the invention is effective at status recovery of a software failure. Although the duplex system and the triplex system have been described in the embodiments, the invention can be also applied to a multiplex system in which four or more systems operate in parallel while shifting job phases.

What is claimed is:

1. A multiplex system comprising:
a predecessor and a successor having identical function to each other;
an input data buffer for temporarily storing input data to be supplied to said predecessor and said successor;
an output data buffer for temporarily storing output data from said predecessor;
a comparator for comparing output data from said successor with output data from said predecessor stored in said output data buffer;
a gate for controlling outputting of said output data from said successor to the outside of the multiplex system in accordance with a result of the comparison by said comparator; and
an execution controller for confirming that said predecessor has normally completed a processing operation on a unit of input data, and allowing said successor to start an operation of processing input data which has been already processed by said predecessor.

2. The multiplex system according to claim 1, wherein said execution controller comprises:
a predecessor monitor for monitoring whether or not said predecessor has normally executed an operation of processing input data; and
a successor controller for controlling start of an operation of processing the next input data by said successor in accordance with a result of monitoring the operation of the predecessor by said predecessor monitor.

3. The multiplex system according to claim 2, further comprising
status recovering means for copying, when an operation failure of said predecessor is detected by said predecessor monitor, the status of said successor before start of processing on the input data to said predecessor, thereby recovering the status of said predecessor to the same status as that in said successor.

4. The multiplex system according to claim 3, wherein said predecessor monitor has means for instructing said predecessor to re-process input data which has failed due to said operation failure at a predetermined timing after the status of said predecessor is recovered by said status recovering means,

5. The multiplex system according to claim 2, wherein said execution controller has means for allowing, when discrepancy of output data of said predecessor and successor is detected by said comparator, said predecessor and successor to re-execute processing on input data corresponding to said output data.

6. The multiplex system according to claim 5, wherein said re-executing means confirms that said predecessor has normally finished the re-execution of processing on said input data and allows said successor to re-execute the processing on said input data.

7. The multiplex system according to claim 2, wherein said predecessor monitor includes output time-out detecting means for detecting whether or not a result is output within predetermined time since processing on a unit of input data is started.

8. The multiplex system according to claim 4, further comprising switching means for switching said successor controller from a normal mode to a reduced mode, when a failure occurs in reprocessing on the same input data by said predecessor, thereby to allow said successor controller to sequentially start the processing operation on next input data by said successor irrespective of a result of monitoring the operation of the predecessor by said predecessor monitor, and to deliver output data from said successor system to the outside via said gate.

9. The multiplex system according to claim 7, wherein said switching means switches said successor controller to said reduced mode in response to a failure notification generated by said predecessor monitor when the number of repetition of the reprocessing on the same input data by said predecessor becomes a predetermined number.

10. The multiplex system according to claim 1, further comprising:
a successor monitor for monitoring whether or not said successor normally executes an operation of processing input data; and
status recovering means for copying the status of said predecessor before start of processing on the next input data to said successor when an operation failure of said successor is detected by said successor monitor, thereby recovering the status of said successor to the same status as that in said predecessor.

11. A multiplex system comprising:
a first system and a second system having identical function to each other;
an input data buffer for temporarily storing input data to be supplied to said first and second systems;
a predecessor monitor for monitoring whether or not said first system has normally completed a processing operation on a unit of input data; and
a successor controller for controlling start of processing operation by said second system on the input data already processed by said first system in accordance with a result of monitoring by said predecessor monitor.

12. The multiplex system according to claim 11, further comprising
means for copying, when an operation failure is detected in said first system by said predecessor monitor, a status of said second system to said first system and, at a predetermined timing, instructing said first system to re-process the input data which has not been successfully processed due to said operation failure.

13. A multiplex system comprising:
first to n-th systems (where n denotes 3 or larger) having identical function;
an input data buffer for temporarily storing input data to be supplied to said first to n-th systems;
(n−1) output data buffers for temporarily storing output data from said first system to the (n−1) th system, respectively;
(n−1) comparing means for comparing output data stored in the i-th output data buffer (where i=1 to n−1) with output data from the (i+1)th system;
gate means for controlling delivering of output data from said n-th system to the outside in accordance with results of the comparison by said plurality of comparators; and
(n−1) execution controlling means for confirming that said i-th system (i=1 to n−1) has normally completed a processing operation on a unit of input data, and allowing the (i+1)th system to start an operation of processing said input data processed by the i-th system.

14. A multiplex system comprising:
a first, second, and third systems having identical function to each other;
an input data buffer for temporarily storing input data to be supplied to said first, second, and third systems;
an output data buffer for temporarily storing output data from said first system;
a comparator for comparing output data from said second system with output data from said first system, stored in said output data buffer;
a gate for controlling delivering of said output data from said second system to the outside in accordance with results of the comparison by said plurality of comparators;
a first execution controller for confirming that said first system has normally completed a processing operation on a unit of input data, and allowing said second system to start an operation of processing the next input data already processed by said first system;
a second execution controller for confirming that said second system has normally completed a predetermined processing operation on a unit of input data, and allowing said third system to start an operation of processing the next input data already processed by said second system; and
means for copying a status of said third system to said first and second systems when discrepancy of output data is detected by said comparator.

15. A multiplex system comprising:
a first, second, and third systems having identical function to each other;
an input data buffer for temporarily storing input data to be supplied to said first, second, and third systems;
a first output data buffer for temporarily storing output data from said first system;
a second output data buffer for temporarily storing output data from said second system;
a first comparator for comparing the output data from said second system with the output data from said first system stored in said first output data buffer;
a second comparator for comparing output data from said third system with output data from said second system stored in said second output data buffer;
a gate for controlling delivering of said output data from said third system to the outside in accordance with results of the comparison by said first and second comparators;
a first execution controller for confirming that said first system has normally completed a processing operation on a unit of input data, and allowing said second system to start an operation of processing the input data already processed by said first system; and
a second execution controller for confirming that said second system has normally completed a processing operation on a unit of input data, and allowing said third system to start an operation of processing the input data already processed by said second system.

16. The multiplex system according to claim 15,
wherein said first execution controller has means for copying, when an operation failure is detected in said first system, a status of said second system before a processing on next input data is started into said first system, and allowing the first system to re-execute processing on input data which has not been successfully processed due to said operation failure, and
said second execution controller has means for copying, when an operation failure is detected in said second system, a status of said third system before processing on next input data is started into said second system, and allowing the second system to re-execute process on input data which has not been successfully processed due to said operation failure.
